(19) United States
(12) Patent Application Publication
(10) Pub. No.: US 2010/0198695 A1
(43) Pub. Date: Aug. 5, 2010

(54) Advertisement Slot Allocation

(75) Inventors: Shanmugavelayutham Muthukrishnan, New York, NY (US); Seyed Vahab Mirrokni Banadaki, Brooklyn, NY (US); Uri Nadav, Hertzliya, IL (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/363,585

(22) Filed: Jan. 30, 2009

(51) Int. Cl. G06Q 30/00; G06Q 40/00; G06Q 90/00

(52) U.S. Cl. 705/14.71; 705/37

(57) ABSTRACT

An item is allocated among two bidders that value the item very differently. The allocation is based on a probability that each of the bidders is allocated the item. The probability that each bidder is allocated the item is determined based on a non-linear function that is applied to bids that are received from the bidders. The item can be allocated semi-randomly subject to the probability that each bidder is allocated the item. A bidder can be required to pay its bid price only when allocated the item or each bidder can be required to pay an all-pay price regardless of which bidder is allocated the item. If the item is allocated in multiple auctions, the bidders can be ensured allocation of the item a minimum number of integer times based on the probabilities.

### BACKGROUND

This document relates to item allocation.

A publisher of a webpage can define advertisement slots in the webpage. The advertisement slots are portions of the webpage in which advertisements can be presented on the webpage. Similarly, publishers of print or other communication media can define advertisement slots that are appropriate for the published media (e.g., advertisement slots in print media, advertisement spots in radio and television media, etc.).

Advertisements can be selected for presentation in the advertisement slots based on an auction of the advertisement slots. The auction can identify a bidder to whom each advertisement slot is allocated based on the bids that are received from the bidders. The price paid by a bidder for allocation of the advertisement slot can be based on the next highest bid that is received from a bidder. For example, in a generalized second price auction, an advertisement slot is allocated to a bidder that submitted a highest bid among the bidders to which the advertisement slot can be allocated. The bidder to which the advertisement slot is allocated pays a price that is equal to the next highest bid submitted by advertisers.

While an advertisement slot can be consistently allocated to a highest bidder for the advertisement slot, allocating the advertisement slot to the highest bidder can yield sub-optimal results. For example, when two bidders provide disparate maximum bids for an advertisement slot, the value of the advertisement slot to the advertisers may not be realized by continuously allocating the advertisement slot to the highest bidder over time because the highest bidder may reduce its bid in response to continually being allocated the advertisement slot.

### SUMMARY

In general, one aspect of the subject matter described in this specification can be implemented in methods that include the actions receiving bid data for an item from first and second bidders, the bid data defining respective bids for allocation of the item for each of the first and second bidders; for each of the first and second bidders, generating allocation probability data for the bidder that defines a probability that the bidder is allocated the item; and allocating the item based on the allocation probability data. Other embodiments of this aspect include corresponding systems, apparatus, and computer program products.

These and other implementations can optionally include one or more of the following features. The methods can further include the action determining an all-pay price for the item, the all-pay price being a price that each bidder pays regardless of which bidder is allocated the item. The all-pay price for the item can be based on a reserve price, the reserve price being a minimum amount that a provider of the item will accept for allocation of the item. The item can be semi-randomly allocated among the first bidder and the second bidder, the semi-random allocation among the first bidder and the second bidder being weighted based on the allocation probability data. The allocation probability data can based on a non-linear function of the respective bids. The non-linear function can be a logarithmic function. The generating and the allocating can be conditioned on a first bid from the first bidder being at least two times larger than a second bid from the second bidder. The action generating allocation probability data can include the actions determining an exponential of a first bid for the first bidder, the exponential of the first bid being the first bid raised to a power between zero and one; determining an exponential of a second bid for the second bidder, the exponential of the second bid being the second bid raised to the power between zero and one; and determining the allocation probability for the first bidder based on a ratio of the exponential of the first bid relative to a sum of the exponential of the first bid and the exponential of the second bid; and determining the allocation probability for the second bidder based a complement of the allocation probability for the first bidder. The methods can further include the action identifying a first bidder and a second bidder from a plurality of bidders from which bid data were received, the first bidder being a bidder for which a highest bid was received and the second bidder being a bidder for which a second highest bid was received. The item can be an advertisement slot.

Particular embodiments of the subject matter described in this specification can be implemented so as to realize one or more of the following advantages. Revenue that is more representative of the value of an advertisement slot to the advertisers can be derived by allocating the advertisement slot to a second highest bidder for a percentage of the total allocations. A bidder can be ensured a percentage of an advertisement slot's total allocations based on the bidder's bid. A bidder can be ensured a minimum number of allocations of the advertisement slot when the bidder is required to pay an all-pay price.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIG. 2 is an illustration of an example webpage for which advertisement slots can be allocated.

FIG. 3A is a flow chart of an example process for non-linear slot allocation.

FIG. 3B is a flow chart of an example process for generating allocation probability data.

FIG. 3C is a flow chart of an example process for non-linear allocation of an advertisement slot for an all-pay auction.

FIG. 4 is block diagram of an example computer system that can be used to facilitate non-linear allocation of advertisement slots.

Like reference numbers and designations in the various drawings indicate like elements.

### DETAILED DESCRIPTION

An auction subsystem allocates an item from a provider semi-randomly between two bidders that value the item very differently. The allocation can be conditioned on the bid for the item for one bidder being a minimum multiple (e.g., 2×, 3×, or some other multiple) of the bid for the item for the other bidder. The relative value of the item to each bidder are represented by bids received from the bidders for the item. The bids are the maximum amounts that the bidders are willing to pay for allocation of the item.

The semi-random allocation of the item is subject to probabilities that each of the bidders is allocated the item. For example, if a first bidder has a 25% probability of being allocated an item and a second bidder has a 75% probability of being allocated the item, then the semi-random allocation can be performed such that the respective probabilities are satisfied. The probability that each bidder is allocated the item is based on a non-linear function applied to the bidder's bid relative to a result of the non-linear function applied to the bidder's bid summed with a result of the non-linear function applied to the other bidder's bid. Allocating items in this manner provides total revenue that is non-linearly proportional to a maximum valuation of the item by the bidders. In some implementations, the item is an advertisement slot.

While reference is made throughout this document to allocating advertisement slots for a webpage, the methods and systems described below for allocating advertisement slots can be implemented for other content environments (e.g., configurations in print media or time slot configurations in television or radio media). Additionally, the methods and systems described below can also be implemented to allocate or sell other items.

### §1.0 Advertisement Publishing and Tracking

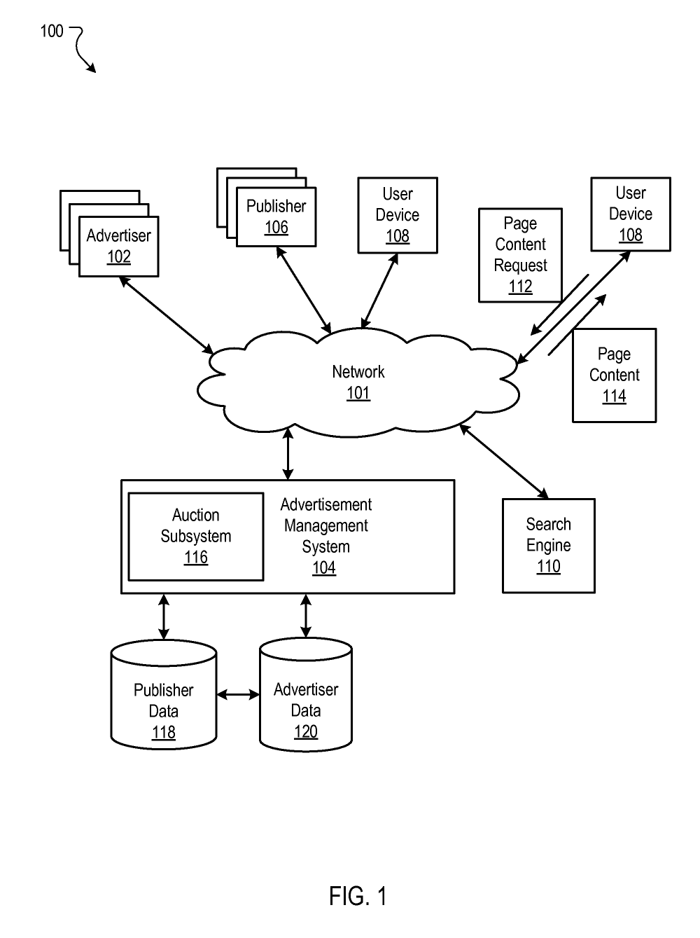

FIG. 1 is a block diagram of an example online environment 100. The online environment 100 can facilitate the identification and serving of content items, e.g., webpages, advertisements, etc., to users. A computer network 101, such as a local area network (LAN), wide area network (WAN), the Internet, or a combination thereof, connects advertisers 102, an advertisement management system 104, publishers 106, user devices 108, and a search engine 110. The online environment 100 may include many thousands of advertisers 102, publishers 106 and user devices 108.

In some implementations, one or more advertisers 102 can directly, or indirectly, enter, maintain, and track advertisement information in the advertising management system 104. The advertisement information can include advertisements that the advertiser 102 has provided for presentation on publisher webpages. The advertisements can be in the form of graphical advertisements, such as banner advertisements, text only advertisements, image advertisements, audio advertisements, video advertisements, advertisements combining one of more of any of such components, etc., or any other type of electronic advertisement document. The advertisements may also include embedded information, such as links, meta-information, and/or machine executable instructions, such as HTML or JavaScript™. The advertisement information, corresponding advertisements and other advertisement data can be stored in an advertiser data store 120 that is coupled to the advertisement management system 104.

A user device 108 can submit a page content request 112 to a publisher 106 or the search engine 110. In some implementations, page content 114 can be provided to the user device 108 in response to the request 112. The page content 114 can include advertisements provided by the advertisement management system 104, or can include executable instructions, e.g., JavaScript™, that can be executed at the user device 108 to request advertisements from the advertisement management system 104. Example user devices 108 include personal computers, mobile communication devices, television set-top boxes, etc.

Requests for advertisements can also be received from the publishers 106. For example, one or more publishers 106 can submit advertisement requests for one or more advertisements to the advertisement management system 104. The system 104 responds by sending the advertisements to the requesting publisher 106 for placement in an advertisement slot that is presented on one or more of the publisher's web properties (e.g., websites and other network-distributed content). The advertisements can include embedded links to landing pages (e.g., pages on the advertisers' 102 websites) that a user device 108 is directed to when a user selects an advertisement that is presented on the publisher's web property. The requests for advertisements can also include content request information. This content request information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the system 104. This combined requested content and advertisements can be sent to the user device 108 that requested the content as page content 114 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106 can include general content servers that receive requests for content (e.g., articles, discussion threads, music, video, graphics, search results, webpage listings, information feeds, etc.), and retrieve the requested content in response to the request. For example, content servers related news content providers, retailers, independent blogs, social network sites, or any other entity that provides content over the network 101 can be a publisher 106.

Advertisements can also be provided using the search engine 110. The search engine 110 can receive search queries. In response, the search engine 110 accesses an index of documents (e.g., from an index of webpages) and generates search results that identify documents that are responsive to the query. An exemplary search engine 110 is described in the article S. Brin and L. Page, “The Anatomy of a Large-Scale Hypertextual Search Engine,” Seventh International World Wide Web Conference, Brisbane, Australia and in U.S. Pat. No. 6,285,999. A Search result can include, for example, a webpage title, a snippet of text extracted from the webpage, and a hypertext link to those webpage. The search results may be grouped into a predetermined number of (e.g., ten) search results.

The advertisers 102, user devices 108, and/or the search engine 110 can also provide usage information to the advertisement management system 104. This usage information can include measured or observed user behavior related to advertisements that have been served, such as, for example, whether or not a conversion or a selection related to an advertisement has occurred. The system 104 performs financial transactions, such as crediting the publishers 106 and charging the advertisers 102 based on the usage information. Such usage information can also be processed to measure performance metrics, such as an impression count, a click-through-rate (“CTR”), conversion rate, etc.

An impression occurs when an advertisement is presented to a user. An impression count tracks the number of times that an advertisement has been presented to a user. For example, when a user device 108 requests a webpage, multiple advertisements can be provided to the user device 108 with the webpage. Each of the advertisements that are provided with the webpage can have an impression counter incremented because an advertisement impression has occurred.

A click-through can occur, for example, when a user of a user device 108, selects or “clicks” on a link to a content item returned by the publisher 106 or the advertising management system 104. The CTR is a performance metric that is obtained by dividing the number of users that clicked on the content item, e.g., a link to a landing page, an advertisement, or a search result, by the number of times the content item was delivered to user devices 108.

A “conversion” occurs when a user consummates a transaction related to a previously served advertisement. What constitutes a conversion may vary from case to case and can be determined in a variety of ways. For example, a conversion may occur when a user clicks on an advertisement, is referred to the advertiser's webpage, and consummates a purchase there before leaving that webpage. Other actions that constitute a conversion can also be used.

### §2.0 Advertisement Slot Allocation

As discussed above, publisher's webpages can include advertisement slots in which advertisements can be presented. The configuration in which advertisement slots are presented on a webpage is generally determined by the publisher 106. For example, a publisher 106 may define a single advertisement slot in which advertisements can be presented each time the webpage is provided to user devices 108. Alternatively, publishers 106 can define two or more advertisement slots for presenting advertisements on a webpage.

The advertisement management system 104 receives slot configuration data for a publisher 106 that defines a number of available advertisement slots, the size of each available advertisement slot and the location of each available advertisement slot. In some implementations, the slot configuration data for a publisher 106 is provided by the publisher 106 in response to a page request from a user device 108, or alternatively is provided by the user device 108 when the page is rendered at the device 108. In response to receiving the slot configuration data, the advertisement management system 104 conducts an auction of the advertisement slots.

An advertiser 102 can provide the advertisement management system 104 data that can be used to identify target webpages on which the advertiser 102 will pay to place advertisements. For example, an advertiser 102 can access the advertisement management system 104 and enter keywords that can be used to target advertisements to a webpage.

An advertiser 102 can also submit bid data to the advertisement management system 104 that specify maximum amounts that the advertiser 102 is willing to pay for an advertisement slot. The bids received from advertisers 102 can be stored and indexed in the advertiser data store 120. The advertisement slots on webpages are allocated to advertisers 102 based on the bid data that is received.

In some implementations, advertisers can bid on particular advertisement slots prior to an auction. The advertisement management system 104 can receive the slot configuration data from publishers 106 and can store and index the slot configuration data in a publisher data store 118. The advertisers 102 can search the publisher webpages by providing advertising queries to the advertisement management system 104. Example advertising queries include keywords, demographics parameters, and topic parameters.

The advertisement management system 104 accesses the publisher data store 118 to identify target webpages that satisfy the advertising queries provided by the advertiser 102. For each target webpage that is identified, the advertisement management system 104 can provide the advertiser 102 information identifying the target webpage, a number of advertisement slots available on the target webpage and other information (e.g., demographic information, performance information, etc.) related to the target webpage. Each advertiser 102 can then provide bids in response, and the slots for a particular webpage are auctioned in response to the webpage being provided to a user device 108.

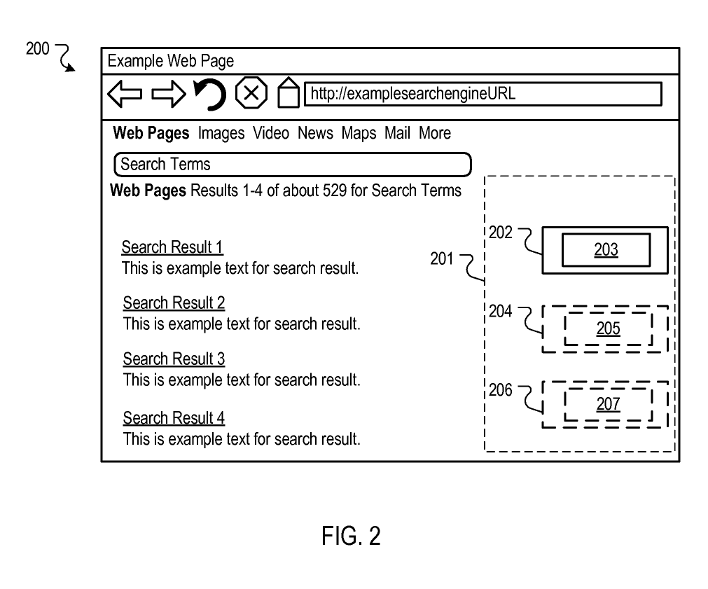

FIG. 2 is an illustration of an example webpage 200 for which advertisement slots can be allocated. The example web page 200 has three advertisement slots 202, 204 and 206 in which three advertisements 203, 205 and 207 can be presented. The advertisement slots 202, 204 and 206 are aligned vertically on the right hand side of the example webpage 200. The advertisement slots 204 and 206 are represented by dashed lines to indicate that advertisements 203 and 205 0can be selectively displayed in these advertisement slots. For example, the publisher 106 can determine whether a single advertisement 203 is presented in advertisement slot 202, or whether an advertisement 203 and/or 205 is also presented in advertisement slots 204 and/or 206.

The advertisement management system 104 can rank the advertisement slots 202, 204 and 206 based on a historical performance of advertisements 203, 205 and 207 that are presented in each of the advertisement slots 202, 204 and 206. The historical performance of advertisements 203, 205 and 207 that are presented in the advertisement slots 202, 204 and 206 can be measured based on the CTR, number of impressions, number of conversions, or other performance metrics of the advertisements.

For example, a CTR of advertisements presented in the advertisement slots 202, 204 and 206 can be monitored over a period of time so that a statistically relevant number of impressions and clicks are received for advertisements 203, 205 and 207 in each of the advertisement slots 202, 204 and 206. A number of clicks of advertisements 203, 205 and 207 presented in each of the advertisement slots 202, 204 and 206 can be divided by a number of impressions for the advertisement slots 202, 204 and 206 to determine a click-through rate of advertisements 203, 205 and 207 presented in each of the advertisement slots 202, 204 and 206. In turn, the advertisement slots 202, 204 and 206 can be ranked based on their respective click-through rates (e.g., in descending order of click-through rates).

When advertisement slots are ranked, the advertisement slots can be allocated in descending order of rank to the advertisers 102 in descending order of bid. For example, the highest ranked advertisement slot (e.g., 202) can be allocated to the advertiser 102 from which the highest bid was received. Similarly, the second and third highest ranked advertisement slots (e.g., 204 and 206) can be allocated to the advertisers 102 from which the second and third highest bids were received, respectively.

Throughout this document, it will be assumed for example purposes that advertisement slot 202 is the highest ranked advertisement slot, advertisement slot 204 is the second highest ranked advertisement slot and that advertisement slot 206 is the third highest ranked advertisement slot in the example webpage 200.

When advertisement slots are allocated as described above, the price that each advertiser pays for an advertisement slot can be determined based on the next highest bid that was received for the advertisement slot. In a generalized second price auction, the advertiser 102 from which the highest bid is received is allocated the advertisement slot 202 and will pay a price equal to the next highest bid that was received. For example, if CPC bids of $3 and $2 are received for the advertisement slot 202 from advertiser A and advertiser B, respectively, then advertiser A will be allocated the advertisement slot 202 and will pay $2 for the advertisement slot if the advertisement is selected by a user.

Similarly, advertisement slots can be allocated as described above in a first price auction. In a first price auction, the advertiser 102 from which the highest bid is received is allocated the advertisement slot 202 and pays a price equal to their bid for the advertisement slot 202. For example, if advertiser A is allocated the advertisement slot 202 based on the bid of $3, advertiser A will pay $3 for allocation of the advertisement slot 202 in a first price auction.

In each of the advertisement slot auctions described, the advertisement slot 202 is allocated to the advertiser 102 from which the highest bid was received. However, continuously allocating an advertisement slot to the highest bidder, as described above, may yield sub-optimal auction results.

For example, when two bidders provide disparate maximum bids for the advertisement slot 202, the value of the advertisement slot 202 may not be realized. Consider an auction of the single advertisement slot 202 among advertiser A and advertiser B, where a bid of $100 has been received from advertiser A and a bid of $1 has been received from advertiser B. The advertisement slot 202 will consistently be allocated to advertiser A if the advertisement slot is simply allocated to the advertiser 102 from which the highest bid was received. However, the price that advertiser A will pay in a second price auction will be $1, even though advertiser A values the advertisement slot at up to $100 based on its maximum bid. The true value of the advertisement slot 202 for each advertiser may be a value other than $1 and $100. However, the revenue received for the advertisement slot 202 will remain at $1 as long as the second highest bid remains at $1.

Over time, the revenue realized from a first price auction for the advertisement slot 202 will also likely approach $1 based on the bids provided for advertisers A and B. While advertiser A will pay $100 for allocation of the advertisement slot 202 in a first price auction when the bid for advertiser A is $100, advertiser A can continually lower its bid for subsequent auctions to identify the next highest bid for the advertisement slot 202. Therefore, advertiser A will discover the next highest bid of $1 for the advertisement slot 202 and bid an incremental amount (e.g., 1 cent) more than the next highest bid to obtain allocation of the advertisement slot 202. Thus, over time, the revenue realized by the first price auction may be only slightly more than the second highest bid and will likely not reflect the value of the advertisement slot to the highest bidder.

As demonstrated above, when a large disparity exists between the values of an advertisement slot to advertisers 102, the revenue received for the advertisement slot may not reflect the value of the advertisement slot to the advertiser from which the highest bid was received.

Revenue that is more reflective of the value of the advertisement slot to the advertisers 102 can be realized by allocating the advertisement slot based on a non-linear function of the bids for the advertisement slot. This advertisement slot allocation based on a non-linear function of the bids for the advertisement slot is referred to as non-linear allocation because the advertisement slot is allocated to an advertiser based on a non-linear proportion of the advertiser's bid price. Additionally, the revenue that is received for the advertisement slot is non-linearly proportional to the bids that are received from the advertisers 102.

### §2.1 Non-Linear Allocation

An auction subsystem 116 of an advertisement management system 104 performs non-linear allocation of advertisement slots such that the revenue received for each advertisement slot is more reflective of the value of the advertisement slot to the advertiser 102. In some implementations, the auction subsystem 116 allocates an advertisement slot pseudo-randomly to advertisers 102 subject to a probability that each advertiser 102 is allocated the advertisement slot. The probability that each advertiser 102 is allocated the advertisement slot can be based on a non-linear function that is applied to the bids for the advertisement slot, as described below. While pseudo-random allocation of advertisement slots is discussed, other allocation techniques can be used (e.g., based on the outcome of a function applied to the probabilities).

The discussion of non-linear allocation of advertisement slots that follows focuses on allocation scenarios where two advertisers 102 submit bids for a single advertisement slot and the advertisement slot is allocated between the two advertisers 102. However, non-linear allocation of more than one advertisement slot to more than two advertisers 102 can be performed.

The auction subsystem 116 receives bid data representing bids from advertisers 102 for an advertisement slot. The bids specify a maximum price that the advertisers 102 are willing to pay to have an advertisement presented in an advertisement slot on a webpage.

For example, bids can be received from two particular advertisers A and B that provided keywords that are satisfied by the example webpage 200. The bids received from advertisers A and B can be stored in the advertiser data store 120. When the advertisement slot 202 of the example webpage 200 is being auctioned, the auction subsystem 116 can retrieve the bids provided by advertisers A and B. The bids retrieved by the auction subsystem 116 can be, for example, disparate CPC bids, as provided in Table 1.

TABLE 1

| | Bid |
|---|---|
| Advertiser A | $100 |
| Advertiser B | $1 |

While the true value of the advertisement slot 202 to each advertiser may be different than their respective bids, the amount that each advertiser 102 bids for the advertisement slot 202 can be considered a measure of the relative value of the advertisement slot to the advertiser 102. For example, advertiser A is willing to pay $100 CPC for the advertisement slot 202, while advertiser B is only willing to pay $1 CPC for the advertisement slot 202. Therefore, advertiser A can be considered to value the advertisement slot 202 at $100 for each click that advertiser A receives, while advertiser B is considered to value the advertisement slot 202 at $1 for each click that advertiser B receives in the advertisement slot 202.

Based on the bids received from the advertisers 102, the auction subsystem 116 generates allocation probability data that defines a probability that each advertiser 102 is allocated the advertisement slot 202. The probability that each advertiser 102 is allocated the advertisement slot is a ratio of a result of a non-linear function applied to the advertiser's bid relative to the result of the non-linear function applied to the advertiser's bid summed with a result of the non-linear function applied to the other advertiser's bid. In some implantations, the non-linear function is an exponential function (e.g., âx where a is an advertiser's bid and x is the exponential factor applied to the bid).

The probability that advertiser A is allocated the advertisement slot can be represented by equation 1.

$$P ( A ) = \frac{{b}_{A}^{α}}{{b}_{A}^{α} + {b}_{B}^{α}} \qquad Equation 1$$

Where,

P(A)=Probability that advertiser A is allocated the advertisement slot;

b_{A}=maximum bid received from advertiser A;

b_{B}=maximum bid received from advertiser B; and

α is selected from [0,1].

Similarly, the probability that advertiser B is allocated the advertisement slot can be represented by Equation 2.

$$P ( B ) = \frac{{b}_{B}^{α}}{{b}_{B}^{α} + {b}_{A}^{α}} \qquad Equation 2$$

Where,

P(B)=Probability that advertiser B is allocated the advertisement slot;

b_{A}=maximum bid received from advertiser A;

b_{B}=maximum bid received from advertiser B; and

α is selected from [0,1].

Continuing with the example above, the probability that advertiser A is allocated the advertisement slot 202 based on equation 1 when α=1/2 is 10/11 (e.g., (100̂.5)/(100̂.5+1̂.5)). Similarly, the probability that advertiser B is allocated the advertisement slot based on equation 2 when α=1/2 is 1/11 (e.g., (1̂.5)/(100̂.5+1̂.5)). In some implementations, the probability that advertiser B is allocated the advertisement slot can also be determined to be the difference between 1 and the probability that advertiser A is allocated the advertisement slot.

Once an allocation probability is determined for each advertiser 102, the auction subsystem 116 can allocate the advertisement slot 202 according to the probabilities. In some implementations, the auction subsystem 116 allocates the advertisement slot 202 pseudo-randomly among the advertisers 102 using the allocation probability for each advertiser 102 as a constraint for the pseudo-random allocation.

Continuing with the example above, the auction subsystem 116 can allocate the advertisement slot 202 pseudo-randomly to either advertiser A or advertiser B, such that advertiser A is allocated the advertisement slot 202 with a 10//11 probability and advertiser B is allocated the advertisement slot 202 with a 1/11 probability. Thus, even though the highest bid was not received from advertiser B, there is a 1/11 chance that advertiser B will be allocated the advertisement slot 202.

While an exponential function has been discussed for example purposes, other non-linear functions can be used to determine the probability that each advertiser 102 is allocated the advertisement slot. For example, the probability ratio described above can be generalized for any two advertisers x and y, as provided in Equation 3.

$$P ( x ) = \frac{F ( x )}{F ( x ) + F ( y )} \qquad Equation 3$$

Where,

P(x)=Probability of advertiser x being allocated the advertisement slot;

F(x)=a non-linear function applied to the bid from advertiser x; and

F(y)=the non-linear function applied to the bid from advertiser y.

The non-linear function F that can be applied to the bids from advertiser x and advertiser y can be, for example, a log function (e.g., F(x)=log(x+1) or F(x)=log(log(x+1)+1)).

In some implementations, an advertisement slot can be allocated among three or more advertisers 102. For example, when bids are received from three or more advertisers 102, the auction subsystem 116 can identify a highest bid and a second highest bid from among the bids. In turn, the auction subsystem 116 can perform the non-linear allocation among the two highest advertisers, as described above. The auction subsystem 116 can alternatively allocate the advertisement slot among three or more advertisers 102 by allocating the advertisement slot among the three or more advertisers 102 based on a probability that each of the advertisers 102 will be allocated the advertisement slot. The auction subsystem 116 can determine the probability that each of the advertisers is allocated the advertisement slot, for example, by applying a non-linear function to the bids of the advertisers. Equation 4 is an example generalized equation for determining the probability that each advertiser among multiple advertisers is allocated the advertisement slot.

$$P ( x ) = \frac{F ( x )}{F ( x ) + F ( y ) + … + F ( z )} \qquad Equation 4$$

Where,

P(x)=Probability of advertiser x being allocated the advertisement slot;

F(x)=a non-linear function applied to the bid from advertiser x; and

F(y)=the non-linear function applied to the bid from advertiser y; and

F(z)=the non-linear function applied to the bid from advertiser z.

When more than one advertisement slot is being allocated by the auction subsystem 116, each of the advertisement slots can be allocated individually, as described above. In some implementations, the advertisement slots can be allocated in order of the rank (e.g., a rank based on historical performance) of the advertisement slot. For example, the highest ranked advertisement slot can be allocated to one of the two advertisers from which the two highest bids were received. The next highest ranked advertisement slot can either be allocated to the advertiser 102 that was not allocated the highest ranked advertisement slot, or to one of the advertisers among the advertisers 102 having the next two highest bids and that were not allocated the highest ranked advertisement slot. The allocation process can be repeated until all advertisement slots on a page are allocated.

Allocating the advertisement slot to advertisers 102 in proportion to the advertisers' bids reduces the likelihood that the advertiser 102 that provided a higher bid can identify the value of the next highest bid. Therefore, the advertiser 102 from that provided the higher bid is more likely to continue to provide a higher bid for the non-linear auction over time than the bid that the advertiser 102 would provide for a second price auction over time. Accordingly, the minimum revenue derived from a non-linear auction will be higher than the minimum revenue derived from a second price auction. While the minimum revenue that is derived from the non-linear auction will be higher than the revenue for the second price auction, the actual revenue derived from the non-linear auction can depend on the manner in which the advertisement slots are priced.

### §2.2 Non-Linear Allocation in an All-Pay Auction

In some implementations, the auction subsystem 116 can allow each advertiser 102 to pay their bid price only when the advertiser 102 is allocated the advertisement slot. Continuing with the example above, advertiser A will pay its bid of $100 for each click of its advertisement in the advertisement slot 202. Similarly, advertiser B will pay $1 for each click that its advertisement receives in the advertisement slot 202. Thus, advertisers A and B only pay when their respective advertisement is presented in the advertisement slot 202 and selected by a user.

In other implementations, the auction subsystem 116 requires that each advertiser 102 pay regardless of whether the advertiser is 102 allocated the advertisement slot. An auction in which each advertiser 102 pays to compete in the auction for an advertisement slot regardless of whether the advertiser 102 is allocated the advertisement slot is referred to as an all-pay auction.

In some implementations, the auction subsystem 116 can determine an all-pay price that advertisers must pay to compete in an all-pay auction for an advertisement slot. Each advertiser that is competing in the all-pay auction for an advertisement slot must pay the all-pay price regardless of which advertiser is allocated the advertisement slot. For example, the advertiser 102 that is allocated the advertisement slot can pay its bid price for the advertisement slot while each advertiser 102 that was not allocated the advertisement slot can be required to pay its bid, a fraction of its bid (e.g., 10%), a fixed fee (e.g., $1.00) or some other price in order to compete in the all-pay auction.

In some implementations, the all-pay price can be a reserve price for the advertisement slot. A reserve price is a minimum amount that a publisher that provides an advertisement slot will accept for allocation of the advertisement slot. For example, a publisher 106 can specify a reserve price of $10 CPC for allocation of an advertisement slot on its webpage. Therefore, no advertiser 102 that bid less than $10 CPC will be allocated the advertisement slot. In an all-pay auction, each advertiser 102 that wants to compete in the auction for the advertisement slot can be required to pay the all-pay price.

An all-pay auction can be combined with the non-linear allocation so that each advertiser 102 pays its bid price regardless of whether the advertiser 102 is allocated the advertisement slot. Non-linear allocation of an advertisement slot combined with an all-pay price that is equal to the advertiser's bid is ex-ante individually rational for each advertiser 102 because each advertiser 102 is allocated the advertisement slot with some probability based on its bid price. However, some advertisers 102 may not want to compete in an auction that requires payment even if the advertiser 102 is not allocated an advertisement slot. For example, when a single advertisement slot is allocated in a single auction, the advertiser 102 may resist paying the all-pay price without a guarantee of receiving allocation of an advertisement slot in return. Therefore, the auction subsystem 116 can adjust the non-linear allocation to ensure that an advertiser 102 does not pay the all-pay price without receiving allocation of an advertisement slot in exchange.

In some implementations, the auction subsystem 116 can ensure that an advertiser 102 does not pay unless it is allocated an advertisement slot over a minimum number of auctions for the advertisement slot. For example, when an advertisement slot is to be auctioned k times, the auction subsystem 116 can compare the probability that an advertiser 102 is allocated the advertisement slot to 1/k. If the probability that the advertiser 102 is allocated the advertisement slot is less than 1/k, the auction subsystem 116 will not allocate the advertisement slot to the advertiser 102 and will not require payment from the advertiser 102. If the probability that the advertiser 102 is allocated the advertisement slot is 1/k or greater, the auction subsystem 116 allocates the advertisement slot to the advertiser for a largest integer number of the k auctions that is less than or equal to the product of the probability and k (i.e., allocations≦probability*k).

Continuing with the example above, if the advertisement slot 202 is to be auctioned 10 or fewer times (i.e., k≦10), the probability (i.e., 1/11) that advertiser B is allocated the advertisement slot 202 is less than 1/k (i.e., 1/10). Therefore, the auction subsystem 116 can prevent the advertisement slot 202 from being allocated to advertiser B and prevent advertiser B from being charged its bid price or any other all-pay price. However, if the advertisement slot 202 is to be auctioned at least 11 times (i.e., k≧11), then auction subsystem 116 can allocate advertisement slot 202 to advertiser B the largest integer number of times that is less than or equal to the product of the probability that advertiser B is allocated the advertisement slot and the number of auctions (i.e., INT(1/11*k)).

In some implementations, the auction subsystem 116 can achieve the minimum allocation results above by charging an advertiser 102 an all-pay price based on the number of the k auctions in which the advertiser 102 is allocated the advertisement slot. The advertiser 102 from which the highest bid is received pays its bid price for its integer number of allocations, where the integer number of allocations is determined as described above. However, the advertiser 102 from which the second highest bid is received only pays a price representing the minimum amount required for its integer number of allocations, which can be less than its bid price. The price paid by the advertiser 102 from which the second highest bid was received can be determined, for example, as the price z that satisfies Equation 5:

$$\frac{{z}_{x}^{α}}{{z}_{x}^{α} + {b}_{y}^{α}} = \frac{⌊ \frac{{b}_{x}^{α}}{{b}_{x}^{α} + {b}_{y}^{α}} * k ⌋}{k} \qquad Equation 5$$

Where:

zₓ=a minimum price paid by the advertiser from which the second highest bid was received;

bₓ=the second highest bid;

k=the number of auctions of the advertisement slot;

b_{y}=the highest bid; and

α=is selected from [0,1].

Allocating and pricing the advertisement slots based on the minimum price required to receive the integer number of allocations prevents an advertiser 102 that is not allocated the advertisement slot from paying an all-pay price. Additionally, allocating the advertisement slot in this manner ensures that an advertiser 102 from which the second highest bid for an advertisement slot is only charged a minimum amount required to receive its integer number of allocations.

### §2.3 Conditional Non-Linear Allocation

In some implementations, non-linear allocation of an advertisement slot is conditioned on a minimum bid disparity being satisfied. In some implementations, the auction subsystem 116 will only perform non-linear allocation when a first bid from a first bidder is at least four times larger than a second bid from a second bidder. When the minimum bid disparity is not satisfied, the auction subsystem 116 can allocate the advertisement slot based on another auction allocation method (e.g., generalized second price auction or first price auction) or the auction subsystem 116 can consistently allocate the advertisement slot to the bidder from which the highest bid was received. The factor of four is provided for example purposes. Other minimum bid disparities can be used as a condition for the non-linear allocation.

### §3.0 Example Process Flows

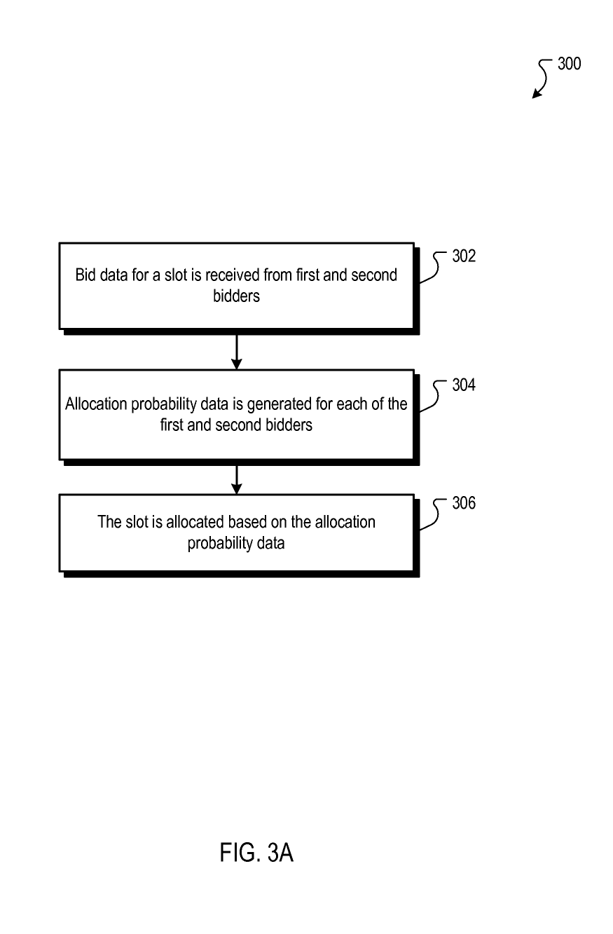

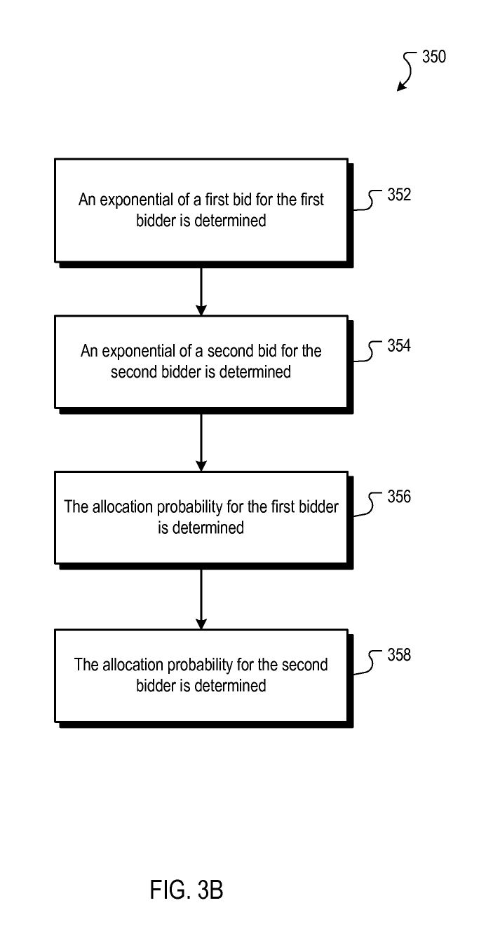

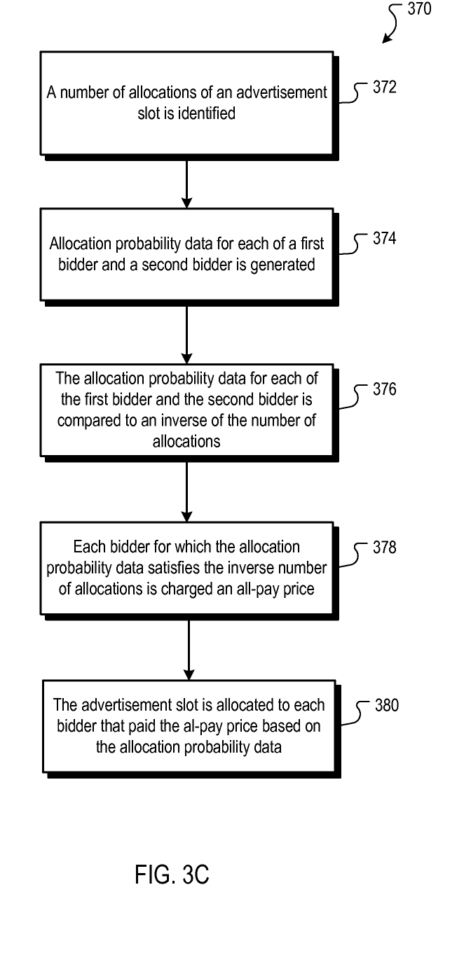

FIG. 3A is a flow chart of an example process 300 for non-linear slot allocation. The process 300 can be implemented, for example, by the auction subsystem 116 and/or the advertisement management system 104 of FIG. 1. The slots can be advertisement slots that are presented, for example, on publishers' web properties or advertisement spots that are presented in print media or other advertising mediums. The process can also be used to allocate or sell other items among bidders.

Bid data for a slot is received from first and second bidders (302). In some implementations, the bid data defines respective bids for allocation of the slot for each of the first and second bidders. In some implementations, the respective bids for the first and second bidders include a first bid for the first bidder and a second bid for the second bidder. In some implementations, the first bidder is the bidder from which a highest bid is received and the second bidder is a bidder from which a second highest bid is received. The bid data can be received, for example, by the auction subsystem 116. The bid data can be received directly from a bidder or retrieved from a data store.

Allocation probability data is generated for each of the first and second bidders (304). In some implementations, the allocation probability data defines a probability that each of the first and second bidders is allocated the slot. The allocation probability data can be determined based on a non-linear function of the respective bids. In some implementations, the non-linear function can be an exponential function. In some implementations, the non-linear function can be a logarithmic function. The allocation probability data can be generated, for example, by the auction subsystem 116.

The slot is allocated based on the allocation probability data (306). In some implementations, the slot is allocated pseudo-randomly among the first and second bidders, where the pseudo-random allocation is weighted based on the allocation probability data. The slot can be allocated, for example, by the auction subsystem 116.

FIG. 3B is a flow chart of an example process 350 for generating allocation probability data. The process 350 can be implemented, for example, by the auction subsystem 116 and/or the advertisement management system 104 of FIG. 1. The process 350 can be iteratively performed for each advertiser that from which a bid for the slot is received.

An exponential of a first bid for the first bidder is determined (352). In some implementations, the exponential of the first bid is the result of the first bid being raised to a power between zero and one. The exponential of the first bid can be determined, for example, by the auction subsystem 116.

An exponential of a second bid for the second bidder is determined (354). In some implementations, the exponential of the second bid is the results of the second bid being raised to a power between one and zero. In some implementations, the power by which the second bid is raised is the same power by which the first bid was raised. The exponential of the second bid can be determined, for example, by the auction subsystem 116.

The allocation probability for the first bidder is determined (356). In some implementations, the allocation probability of the first bidder is based on a ratio of the exponential of the first bid relative to a sum of the exponential of the first bid and the exponential of the second bid. The allocation probability of the first bidder can be determined, for example, by the auction subsystem 116.

The allocation probability of the second bidder is determined (356). In some implementations, the allocation probability of the second bidder is based on a complement of the allocation probability of the first bidder. For example, the allocation probability can be the difference between one and the allocation probability for the first bidder. In some implementations, the allocation probability of the second bidder can be based on a ratio of the exponential of the second bid relative to a sum of the exponential of the second bid and the exponential of the first bid. The allocation probability of the second bidder can be determined, for example, by the auction subsystem 116.

FIG. 3C is a flow chart of an example process 370 for non-linear allocation of an advertisement slot for an all-pay auction. The process 370 can be implemented, for example, by the auction subsystem 116 and/or the advertisement management system 104 of FIG. 1. The process 370 can be iteratively performed for each advertisement slot to be allocated on a webpage.

A number of allocations of an advertisement slot is identified (372). In some implementations, the number of allocations can be specified by the publisher of the webpage on which the advertisement slot is defined. In some implementations, the number of allocations can be a number of allocations (e.g., 100 allocations) for a continuously auctioned advertisement slot that will be performed using the same bids. The integer number of allocations can be identified, for example, by the auction subsystem 116.

Allocation probability data for each of a first bidder and a second bidder is generated (374). In some implementations, the allocation probability data defines a probability that each of the first and second bidders is allocated the slot. The allocation probability data can be determined based on a non-linear function of the respective bids. In some implementations, the non-linear function can be an exponential function. In some implementations, the non-linear function can be a logarithmic function. The allocation probability data can be generated, for example, by the auction subsystem 116.

The allocation probability data for each of the first bidder and the second bidder is compared to an inverse of the number of allocations (376). The allocation probability data can be compared to the inverse of the number of allocations, for example, by the auction subsystem 116.

Each bidder for which the allocation probability data satisfies the inverse number of allocations is charged an all-pay price (378). The all-pay price can be charged, for example, by the auction subsystem 116 for each auction instance.

The advertisement slot is allocated to each bidder that paid the all-pay price based on the allocation probability data (380). In some implementations, each bidder that paid the all-pay price is allocated a largest integer number of the number of allocations that is less than a product of the number of allocations and the allocation probability data for the bidder. The advertisement slot can be allocated, for example, by the auction subsystem 116.

### §4.0 Example Computer System

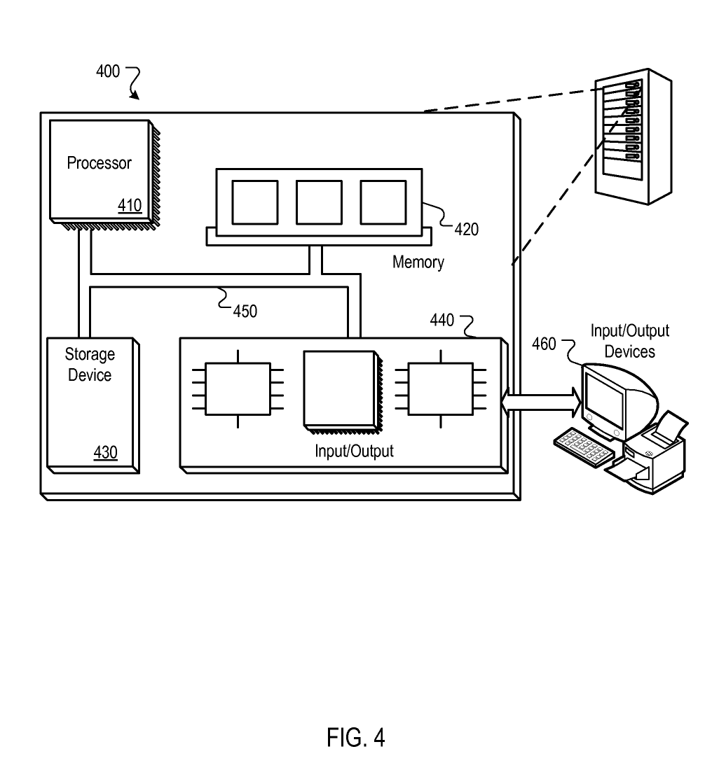

FIG. 4 is block diagram of an example computer system 400 that can be used to facilitate non-linear allocation of advertisement slots. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460.

The auction subsystem 116 and/or advertisement management system 104 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The auction subsystem 116 and/or advertisement management system 104 can be distributively implemented over a network, such as a server farm, or can be implemented in a single computer device.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system,” “processing devices” and “subsystem” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, data processing apparatus.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. While reference is made to delivering advertisements, other forms of content including other forms of sponsored content can be delivered.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving bid data for an item from first and second bidders, the bid data defining respective bids for allocation of the item for each of the first and second bidders;
for each of the first and second bidders, generating allocation probability data for the bidder that defines a probability that the bidder is allocated the item; and
allocating the item based on the allocation probability data.

2. The method of claim 1, further comprising determining an all-pay price for the item, the all-pay price being a price that each bidder pays regardless of which bidder is allocated the item.

3. The method of claim 2, wherein the all-pay price for the item is based on a reserve price, the reserve price being a minimum amount that a provider of the item will accept for allocation of the item.

4. The method of claim 1, wherein the item is semi-randomly allocated among the first bidder and the second bidder, the semi-random allocation among the first bidder and the second bidder being weighted based on the allocation probability data.

5. The method of claim 1, wherein the allocation probability data is based on a non-linear function of the respective bids.

6. The method of claim 5, wherein the non-linear function is a logarithmic function.

7. The method of claim 1, wherein the generating and the allocating are conditioned on a first bid from the first bidder being at least two times larger than a second bid from the second bidder.

8. The method of claim 7, further comprising always allocating the item to the first bidder when the first bid is greater than the second bid but less than two times larger than the second bid.

9. The method of claim 1, wherein generating allocation probability data comprises:
determining an exponential of a first bid for the first bidder, the exponential of the first bid being the first bid raised to a power between zero and one;
determining an exponential of a second bid for the second bidder, the exponential of the second bid being the second bid raised to the power between zero and one; and
determining the allocation probability for the first bidder based on a ratio of the exponential of the first bid relative to a sum of the exponential of the first bid and the exponential of the second bid; and
determining the allocation probability for the second bidder based a complement of the allocation probability for the first bidder.

10. The method of claim 1, further comprising identifying a first bidder and a second bidder from a plurality of bidders from which bid data were received, the first bidder being a bidder for which a highest bid was received and the second bidder being a bidder for which a second highest bid was received.

11. The method of claim 1, wherein the item is an advertisement slot.

12. A system, comprising:
an advertisement management system comprising one or more processors to receive slot configuration data defining a slot that is available on a publisher's property for presenting advertisements and to receive bid data for the slot from first and second bidders, the bid data defining respective bids for allocation of the slot for each of the first and second bidders;
a data store couple to the advertisement management system to store the slot configuration data and the respective bids; and
an auction subsystem coupled to the advertisement management system and the data store, the auction subsystem operable to determine allocation probability data that defines a probability with which the slot is allocated to each of the first and the second bidders and to allocate the slot among the first and second bidders based on the allocation probability data.

13. The system of claim 12, wherein the auction subsystem is further operable to determine an all-pay price that each bidder pays regardless of which bidder is allocated the slot.

14. The system of claim 13, wherein the all-pay price is based on a reserve price that defines a minimum amount that a publisher that provides the slot will accept for allocation of the slot.

15. The system of claim 12, wherein the allocation probability data is based on a non-linear function of the respective bids

16. The system of claim 12 wherein the allocation of the slot is a pseudo-random allocation among the first and second bidders.

17. The system of claim 12, wherein the allocation based on the probability data is conditioned on a first bid from the first bidder being at least four times larger than a second bid from the second bidder.

18. The system of claim 17, wherein the auction subsystem is operable to allocate the slot to the first bidder when the first bid is greater than the second bid but less than four times greater than the second bid.

19. The system of claim 12, wherein the advertisement management system and the auction subsystem are implemented as independent processing systems in a distributed processing network.

20. The system of claim 12, wherein the allocation probability data for the first bidder is based on a ratio of an exponential of the first bid relative to a sum of the exponential of the first bid and the exponential of the second bid.

21. The system of claim 20, wherein the allocation probability data for the second bidder is based on a complement of the allocation probability data for the first bidder.
